(19) United States
(12) Patent Application Publication
(10) Pub. No.: US 2004/0022398 A1
(43) Pub. Date: Feb. 5, 2004

(54) Method and apparatus for reducing noise using pre-recorded information on a semiconductor memory

(75) Inventors: Tsuei-Chi Yeh, Hsinchu (TW); Peter J. Holzmann, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Winbond Electronics Corporation, Hsinchu (TW)

(21) Appl. No.: 10/211,474

(22) Filed: Aug. 1, 2002

(51) Int. Cl. H04B 15/00

(52) U.S. Cl. 381/94.1; 381/94.3

(57) ABSTRACT

A noise reduction apparatus (and methods). The apparatus has a housing and a processing device coupled to the housing. A sensor is coupled to the processing device and may be adapted to the housing. The sensor is adapted to determine a noise signal. A programmable memory is coupled to the processing device. The programmable memory device comprises 1 to N periodic frequency band limited noise wave shapes that are capable of reducing an intensity level of the noise signal. The apparatus also has an output device that is coupled to the processing device. The output device is adapted to output the periodic frequency band limited noise wave shape that is capable of reducing the intensity level of the noise signal.

### BACKGROUND OF THE INVENTION

The present invention generally relates to signal processing techniques of audio information using semiconductor devices. More particularly, the present invention provides a method and system for reducing unwanted background noise using one or more semiconductor memories with pre-recorded information. Merely by way of example, the present invention is implemented using such method in a computer appliance, but it would be recognized that the invention has a much broader range of applicability. The invention can be applied to other types of environments such as a telephone, an air conditioner, automobile, and others.

As the human population increased, we have experienced more and more noise, which is one of the most widespread pollutants today. Noise is often thought of as unwanted sound. Originally, it was derived from the Latin word “nausea,” which means seasickness. Noise often comes from many sources. Noise from road traffic, jet planes, jet skis, garbage trucks, construction equipment, manufacturing processes, lawn mowers, leaf blowers, and boom boxes, to name a few, are among the unwanted sounds that are routinely broadcast into the air. Many problems exist with noise. It is not only unwanted, but it has detrimental side influences to human beings. For example, noise negatively affects human health and well-being. Some problems related to noise include hearing loss, stress, high blood pressure, sleep loss, distraction and lost productivity, and a general reduction in the quality of life and opportunities for tranquillity.

We often experience noise in a number of ways. Human beings are often victims and causes of noise. Noise can be generated by operating noisy appliances or equipment. There are also instances when we experience noise generated by other people just as people experience second-hand smoke. While in both instances, noises are equally damaging, second-hand noise is more troubling because it has negative impacts on us but is put into the environment by others, without our consent. To address some of these problems, organizations such as The Noise Pollution Clearinghouse, P.O. Box 1137, Montpelier Vt. 05601-1137 exist. See http://www.nonoise.org.

Certain technologies have been proposed to reduce noise and in particular background noise. As merely an example, background noise has been reduced by using an acoustic interference technique. Here, the technique senses background noise, processes a signal corresponding to the noise, generates an inverted signal from such noise, and outputs the inverted signal using a load speaker. By way of the output of the inverted noise signal, the actual noise interferes destructively with the inverted signal and cancels such background noise out. Examples of such technique are described in G. B. Chaplin in Method and Apparatus for Canceling Vibration in U.S. Pat. No. 4,489,441 and in ‘Active Acoustic Attenuator’ by G. E. Warnaka et al. in U.S. Pat. No. 4,473,906. Other techniques are described by C. A. Wiklof in U.S. Pat. No. 6,232,994 and U.S. Pat. No. 5,559,893 by Krokstad et al. All of these techniques, however, do not effectively reduce noise.

From the above, it is seen that an improved way of reducing unwanted noise is highly desirable.

### SUMMARY OF THE INVENTION

According to the present invention, a technique including a method and system for processing audio signals is provided. More particularly, the present invention provides a method and system for reducing unwanted background noise using one or more programmable semiconductor memories with pre-recorded information. Merely by way of example, the present invention is implemented using such method in a computer appliance, but it would be recognized that the invention has a much broader range of applicability. The invention can be applied to other types of environments such as a telephone, an air conditioner, automobile, and others.

In a specific embodiment, the present invention provides a method and system that uses pre-recorded anti noise wave shapes that reduce the environmental noise when applied to a speaker with the correct phase and amplitude. The system includes a microphone that senses the noise in the environment. An amplifier amplifies the noise signal to a more usable signal level. The amplified noise signal is then band limited by one or more band filters. From each band filter output, phase, and amplitude information are retrieved by a peak detector and a phase locked loop (“PLL”). The peak detector output and the PLL control the amplitude and the sample frequency of the pre-recorded noise pattern from the signal storage array. The array signals are summed, band-limited and then fed to a speaker output. The outputted signals then combine with the background noise to reduce an intensity level of the noise through interference.

In an alternative specific embodiment, the invention provides a method for reducing undesirable audio using a programmable semiconductor memory device. The method includes receiving incoming audio information from a substantially continuous stream of the audio information. The method also filters the incoming audio information into a plurality of wave forms. Each of the wave forms has a plurality of components, including a phase information and an amplitude information. The method identifies one or more wave forms having a phase information and an amplitude information from a library of preprogrammed audio information. One or more wave forms are selected from the library. Next, the method outputs information from one or more of the wave forms in a selected manner to substantially reduce an intensity level of a portion of the substantially continuous stream of the audio information.

In yet an alternative embodiment, the invention provides a noise reduction apparatus. The apparatus has a housing and a processing device coupled to the housing. A sensor is coupled to the processing device and may be adapted to the housing. The sensor is adapted to determine a noise signal. A programmable memory is coupled to the processing device. The programmable memory device comprises 1 to N periodic frequency band limited noise wave shapes that are capable of reducing an intensity level of the noise signal. The apparatus also has an output device that is coupled to the processing device. The output device is adapted to output the periodic frequency band limited noise wave shape that is capable of reducing the intensity level of the noise signal.

Many benefits are achieved by way of the present invention over conventional techniques. The present invention can be implemented using conventional hardware and/or software technologies. The invention can also be used with a number of small mobile devices due to its small form factor. In other embodiments, the invention also provides an effective way of reducing background noise, which has detrimental influences. The invention can also be provided in a programmable semiconductor memory, which allows a user to adjust the system to be effective with the particular background noise. Such background noise may change over time or other parameter. The invention also uses a series of band path filters to more accurately define the noise and therefore reduce the noise more effectively. Depending upon the embodiment, one or more of these benefits may be achieved. These and other benefits will be described in more throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified diagram of a mobile telecommunication system according to an embodiment of the present invention;

FIG. 2 is a simplified diagram of a mobile telephone handset according to an embodiment of the present invention;

FIG. 3 is a block diagram of a noise reduction system according to an embodiment of the present invention;

FIG. 4 is a detailed block diagram of a noise reduction apparatus according to an embodiment of the present invention;

FIGS. 5 and 6 are simplified flow diagrams of methods according to embodiments of the present invention;

FIG. 7 is a simplified diagram of a programming method according to an embodiment of the present invention

### DESCRIPTION OF THE SPECIFIC EMBODIMENTS

According to the present invention, a technique including a method and system for processing audio signals is provided. More particularly, the present invention provides a method and system for reducing unwanted background noise using one or more programmable semiconductor memories with pre-recorded information. Merely by way of example, the present invention is implemented using such method in a computer appliance, but it would be recognized that the invention has a much broader range of applicability. The invention can be applied to other types of environments such as a telephone, an air conditioner, automobile, and others.

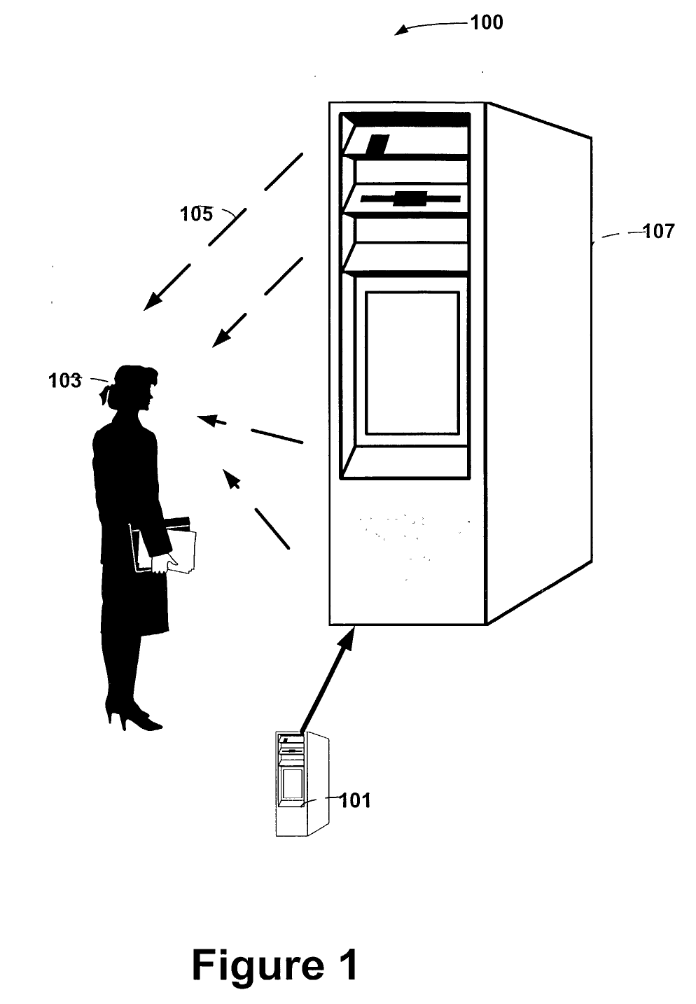

FIG. 1 is a simplified diagram of a noise reduction system 100 according to an embodiment of the present invention. This diagram is merely an illustration and should not unduly limit the scope of the claims herein. One of ordinary skill in the art would recognize many other variations, modifications, and alternatives. As shown, the system 100 includes a computer box 101, which has familiar elements such as a fan, hard disk, power supplies, and other noise causing devices. The noise causing devices create unwanted sounds 105 that are experienced by a user 103. The user can be an engineer, a staff person, or other person who has to work in an environment with computers. Although the computer box is really a smaller device 101, it may seem much larger 107 at times from the noise causing devices. The present invention, which will be defined more fully below, attempts to substantially reduce the unwanted noise 105 from the environment. The invention, however, can be used to substantially reduce other types of background noise. Such other types of background noise are described more fully below.

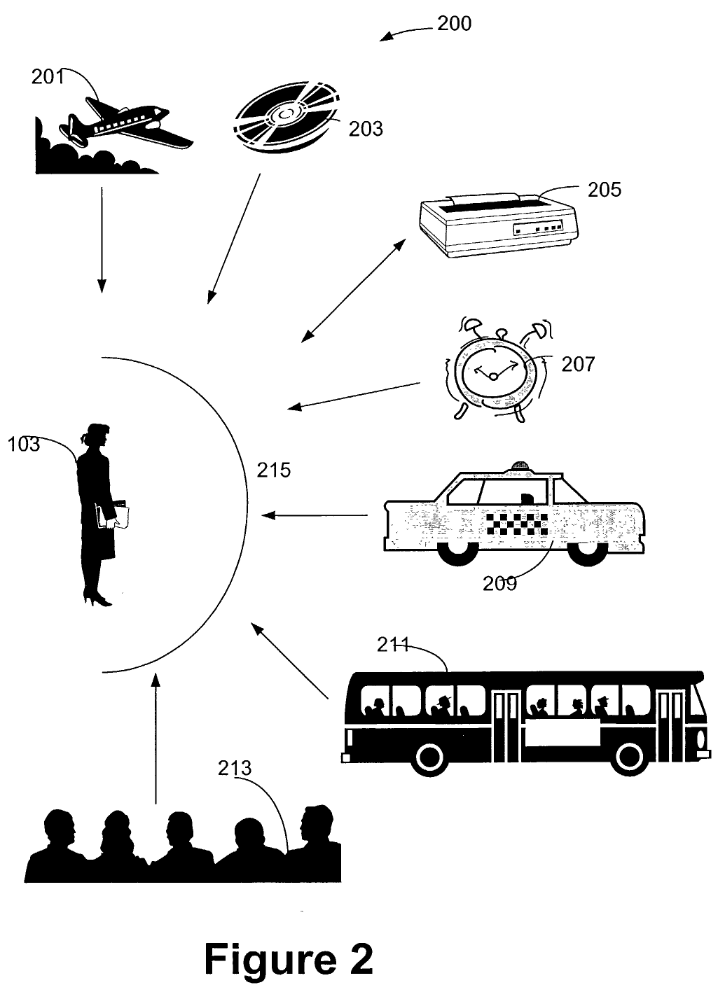

FIG. 2 is a simplified illustration 200 of other types of background noise according to an embodiment of the present invention. This diagram is merely an illustration and should not unduly limit the scope of the claims herein. One of ordinary skill in the art would recognize many other variations, modifications, and alternatives. As shown, there are many examples of sources of noise, which can be noise to a person 103. For example, the noises can come from sources such as an automobile 203, other human being 205, construction 207, and others. In general, there are often two types of noises in the simplified example. The first type of noise has a periodic frequency, which may increase or decrease in intensity. The other type is an impulse or shock, which comes in the form of a burst. Many if not all of noises being in these two types or a combination of these types. The present invention uses a novel system and method for reducing each of these types of noises using an interference technique. Further details of such interference technique are provided below.

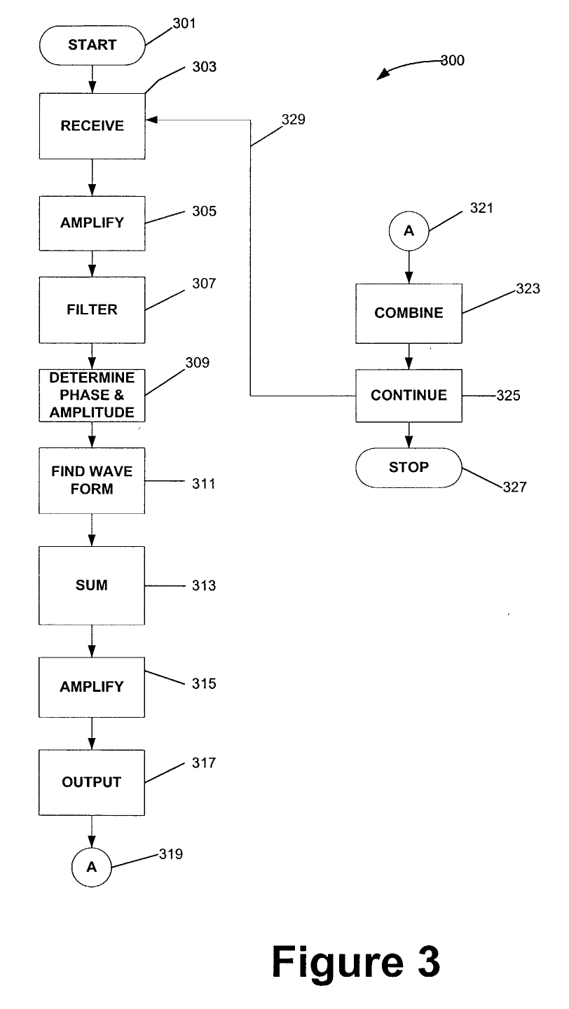

FIG. 3 is a simplified diagram 300 of a noise reduction method according to an embodiment of the present invention. This-diagram is merely an illustration and should not unduly limit the scope of the claims herein. One of ordinary skill in the art would recognize many other variations, modifications, and alternatives. As shown, the method begins with start, step 301. The method then receives (step 303) an audio signal or information from an outside source. Preferably, the noise is received with a speaker. The audio information is basically noise, which is derived from one or more sources Some of these noise sources have been described. They include noise from road traffic, jet planes, jet skis, garbage trucks, construction equipment, manufacturing processes, lawn mowers, leaf blowers, and boom boxes, to name a few, are among the unwanted sounds that are routinely broadcast into the air. Noise can also come from other people and other sources.

The audio information is amplified, step 305. The amplification process increases an intensity level or amplifies the audio information to a more usable signal level for processing. Preferably, the amplifier can be a fixed amplifier or an AGC amplifier. The method filters (step 302) the amplified audio information. Preferably, the method uses a plurality of band pass filters to identify each of the noise components. From each band filter output, phase and amplitude information (step 309) of a repetitive waveform is retrieved by a peak detector and a phase lock loop device (“PLL”). That is, predictable noises often include a predictable pattern, which can be identified by selected characteristics. Such characteristics include a relatively repetitive waveform, where phase and amplitude information can be identified. Due to the predictable characteristics of the noise source, corresponding band-limited periodic noise waves can be pre-recorded in a storage array.

Next, the method finds a matching wave form or forms, step 311. The waveforms are stored in a storage array. The storage array includes a plurality of the prerecorded waveforms each of which resemble a specific predictable noise. The storage array is preferably a flash memory device, which can store an analog version of the waveforms. Although a digital flash memory device can be used, analog is preferable. An example, such analog flash memory device is described in U.S. Pat. No. 5,959,883, commonly owned and hereby incorporated by reference for all purposes.

One or more of these pre-recorded waves can be played back at a variable sample rate and with an externally controlled amplitude. The phase information, obtained from each of 1 to N of the PLL can be used to generate the sample frequency for each of 1 to N waves. Also, the amplitude information from each of 1 to N of the peak detectors can be used to control the amplitude of each of 1 to N waves. Each of 1 to N waves are summed 313 and band-limited. The summed wave form is then shaped and amplified 315, which may also occur before each of the waves is summed. The summed wave is then fed to a speaker for output 317. The method continues through connectors 319, 321.

The method outputs the summed wave 180 degrees out of phase from the incoming audio information to substantially cancel the components of continuing incoming audio information. That is, the summed wave combines (step 323) with continuing incoming audio information to substantially cancel out the incoming waveform. The noise is therefore substantially reduced. The method continues (step 325) and returns to step 303. Alternatively, the method goes to step 327 and stops.

Although the above has been described in terms of a specific sequence of steps, it would be recognized that there can be many alternatives, variations, and modifications. For example, any of the above steps can be separated or combined. Alternatively, some of the steps can be implemented in software or a combination of hardware and software. Alternatively, the above steps can be further integrated in hardware or software or hardware and software or the like. It is also understood that the examples and embodiments described herein are for illustrative purposes only and that various modifications or changes in light thereof will be suggested to persons skilled in the art and are to be included within the spirit and purview of this application and scope of the appended claims.

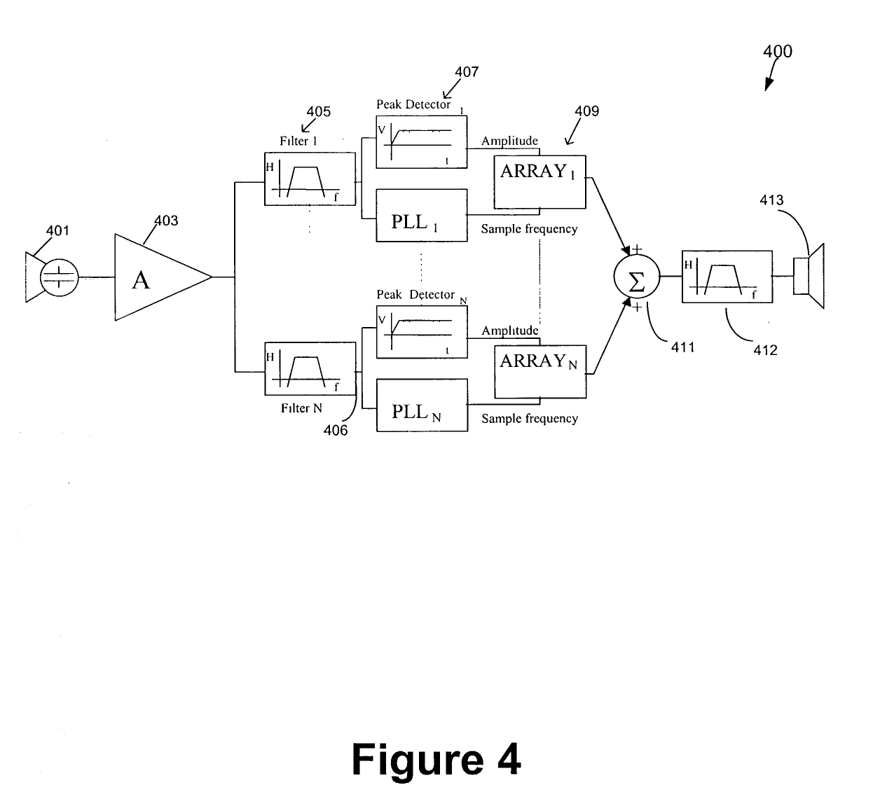

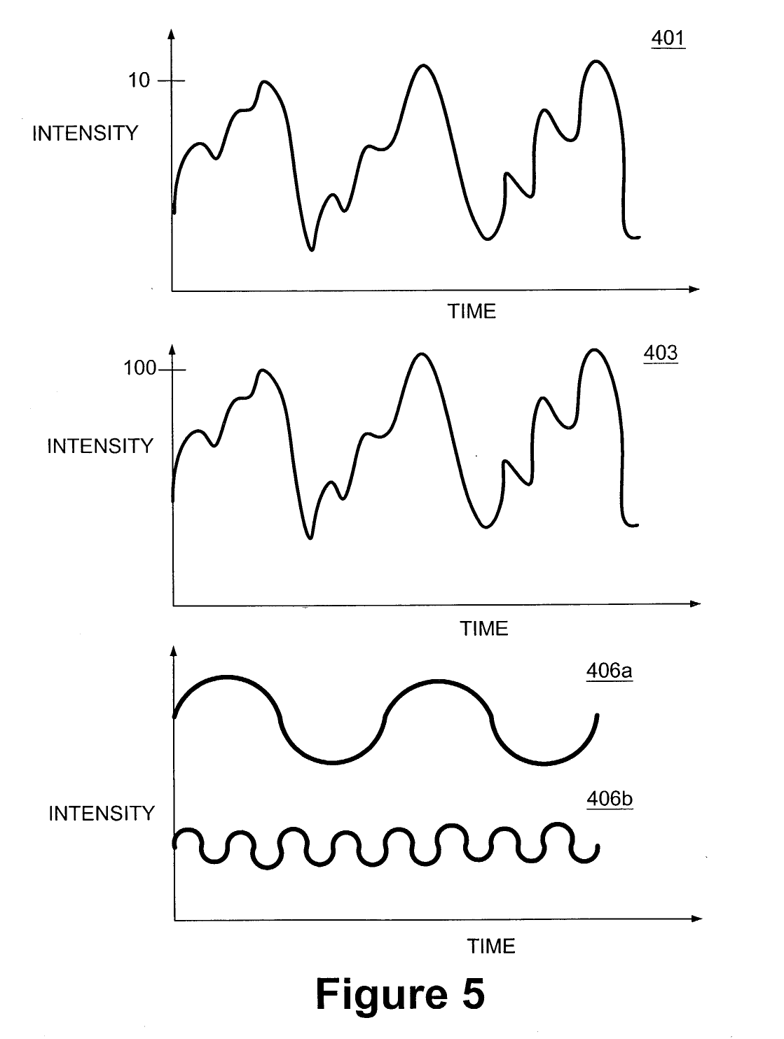

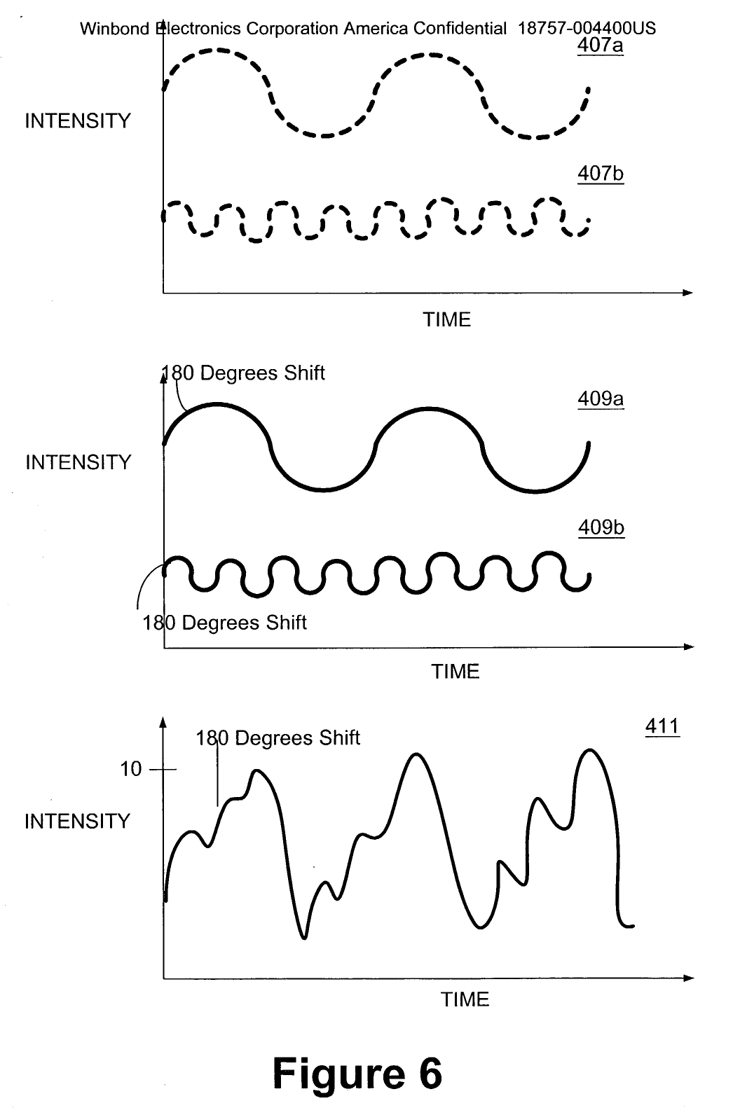

FIG. 4 is a detailed block diagram 400 of a noise reduction system according to an embodiment of the present invention. This diagram is merely an illustration and should not unduly limit the scope of the claims herein. One of ordinary skill in the art would recognize many other variations, modifications, and alternatives. We can also refer to FIGS. 5 and 6, which illustrate the audio information 500 along each of the elements in the system, which uses like reference numerals for cross referencing purposes only. The present system can be used to reduce predictable noise sources in a specific embodiment. The block diagram 400 includes a variety of elements such as a microphone 401 that senses noise in the vicinity of noise sources. Some of these noise sources have been described. They include noise from road traffic, jet planes, jet skis, garbage trucks, construction equipment, manufacturing processes, lawn mowers, leaf blowers, and boom boxes, to name a few, are among the unwanted sounds that are routinely broadcast into the air. Noise can also come from other people and other sources.

An amplifier 403 increases an intensity level or amplifies the microphone output signal to a more usable signal level. The amplifier can be coupled to a filter to eliminate any non-useful noise in the signal level. This amplifier can be a fixed amplifier or an AGC amplifier. In another embodiment, it is also possible to use two or more microphones to sense the noise signal. If two or more microphones are used, signal processing can occur in parallel or serial depending upon the application.

The amplified noise signal is band limited by one or more band pass filters 405. From each band filter output, phase and amplitude information of a repetitive waveform is retrieved by a peak detector and a phase lock loop device (“PLL”). That is, predictable noises often include a predictable pattern, which can be identified by selected characteristics. Such characteristics include a relatively repetitive waveform, where phase and amplitude information can be identified. Due to the predictable characteristics of the noise source, corresponding band-limited periodic noise waves can be pre-recorded in a storage array. The storage array includes a plurality of these pre-recorded waveforms each of which resemble a specific predictable noise.

One or more of these pre-recorded waves can be played back at a variable sample rate and with a externally controlled amplitude. The phase information, obtained from each of 1 to N of the PLL can be used to generate the sample frequency for each of 1 to N waves. Also, the amplitude information from each of 1 to N of the peak detectors can be used to control the amplitude of each of 1 to N waves. Each of 1 to N waves are summed 411 and band-limited. The summed wave form is then shaped and amplified 412, which may also occur before each of the waves is summed. The summed wave is then fed to a speaker output 413. In this way, the system contains 1 to N independent controlled loops, separated by frequency bands. For each loop, the phase and the amplitude of the output waveform to the speaker are controlled, such that the amplitude matches the amplitude from the external noise source and the phase is shifted by 180 degrees, resulting in a noiseless or reduced noise environment. Further details of the system can be found throughout the present specification and more particularly by the methods illustrated below.

FIGS. 5 and 6 are simplified flow diagrams of methods according to embodiments of the present invention. These diagrams are merely examples and should not unduly limit the scope of the claims herein. One of ordinary skill in the art would recognize many other variations, modifications, and alternatives. As shown, each plot shows a signal corresponding to an element in the prior figure. A signal is first received, as shown by reference numeral 401. Here, intensity is plotted against the vertical axis and time along the horizontal axis. Next, the signal is amplified, as shown by the increase in intensity along the vertical axis. In a specific embodiment, an amplifier increases an intensity level or amplifies the microphone output signal to a more usable signal level. The amplifier can be coupled to a filter to eliminate any non-useful noise in the signal level. This amplifier can be a fixed amplifier or an AGC amplifier.

Next, the amplified noise signal is band limited by one or more band pass filters. The band pass filters separates the amplified noise into signal 406a and 406b. From each band filter output, phase and amplitude information of a repetitive waveform is retrieved by a peak detector and a phase lock loop device (“PLL”), as shown by reference numbers 407a, and 407b. That is, predictable noises often include a predictable pattern, which can be identified by selected characteristics. Such characteristics include a relatively repetitive waveform, where phase and amplitude information can be identified. Due to the predictable characteristics of the noise source, corresponding band-limited periodic noise waves can be pre-recorded in a storage array. The storage array includes a plurality of these pre-recorded waveforms each of which resemble a specific predictable noise.

One or more of these pre-recorded waves can be played back at a variable sample rate and with a externally controlled amplitude. The phase information, obtained from each of 1 to N of the PLL can be used to generate the sample frequency for each of 1 to N waves. Also, the amplitude information from each of 1 to N of the peak detectors can be used to control the amplitude of each of 1 to N waves, as shown by reference numerals 409a and 409b. Each of 1 to N waves are summed and band-limited. The summed wave form is then shaped and amplified 411, which may also occur before each of the waves is summed. The summed wave is then fed to a speaker output. In this way, the system contains 1 to N independent controlled loops, separated by frequency bands. For each loop, the phase and the amplitude of the output waveform to the speaker are controlled, such that the amplitude matches the amplitude from the external noise source and the phase is shifted by 180 degrees, resulting in a noiseless or reduced noise environment.

Although the above has been described in terms of specific hardware features, it would be recognized that there can be many alternatives, variations, and modifications. For example, any of the above elements can be separated or combined. Alternatively, some of the elements can be implemented in software or a combination of hardware and software. Alternatively, the above elements can be further integrated in hardware or software or hardware and software or the like. It is also understood that the examples and embodiments described herein are for illustrative purposes only and that various modifications or changes in light thereof will be suggested to persons skilled in the art and are to be included within the spirit and purview of this application and scope of the appended claims.

A method according to an embodiment of the present invention may be outlined as follows:

1. Identify noise source;

2. Initiate process to program memory array;

3. Receive audio signal from noise source;

4. Amplify audio signal;

5. Filter audio signal into its components;

6. Determine phase and amplitude information;

7. Process phase and amplitude information;

8. Program array of memory cells; and

9. Perform other steps, as desired.

The above sequence of steps provides a way to program a memory using a method according to an embodiment of the present invention. The programming method allows for a user to easily implement a noise reduction technique on a variety of noise sources. The programming method uses a programmable memory device, which allows for digital and/or analog signals to be stored in an array and later retrieved. Further details of the method are provided by way of the Fig. below.

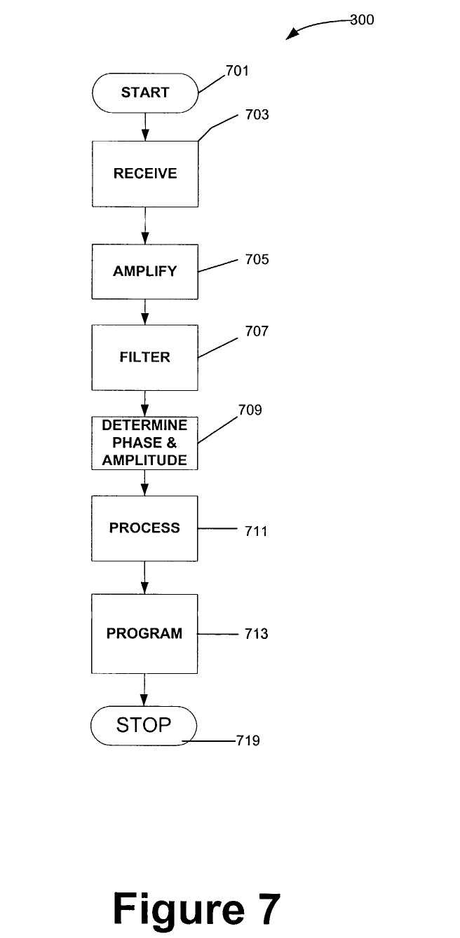

FIG. 7 is a simplified diagram of a programming method according to an embodiment of the present invention. This diagram is merely an illustration and should not unduly limit the scope of the claims herein. One of ordinary skill in the art would recognize many other variations, modifications, and alternatives. As shown, the method begins with start, step 701. The method then receives (step 703) an audio signal or information from an outside source, which will be used to program an array of memory cells. Preferably, the noise is received with a speaker. The audio information is basically noise, which is derived from one or more sources Some of these noise sources have been described. They include noise from road traffic, jet planes, jet skis, garbage trucks, construction equipment, manufacturing processes, lawn mowers, leaf blowers, and boom boxes, to name a few, are among the unwanted sounds that are routinely broadcast into the air. Noise can also come from other people and other sources.

The audio information is amplified, step 705. The amplification process increases an intensity level or amplifies the audio information to a more usable signal level for processing. Preferably, the amplifier can be a fixed amplifier or an AGC amplifier. The method filters (step 702) the amplified audio information. Preferably, the method uses a plurality of band pass filters to identify each of the noise components. From each band filter output, phase and amplitude information (step 709) of a repetitive waveform is retrieved by a peak detector and a phase lock loop device (“PLL”). That is, predictable noises often include a predictable pattern, which can be identified by selected characteristics. Such characteristics include a relatively repetitive waveform, where phase and amplitude information can be identified. Due to the predictable characteristics of the noise source, corresponding band-limited periodic noise waves can be pre-recorded in a storage array.

Next, the method processes the wave form or forms, step 711. The waveforms are stored in a storage array. The storage array will be programmed with a plurality of the waveforms each of which is a component to the noise. The storage array is preferably a flash memory device, which can store an analog version of the waveforms. Although a digital flash memory device can be used, analog is preferable. An example, such analog flash memory device is described in U.S. Pat. No. 5,959,883, commonly owned and hereby incorporated by reference for all purposes. The method stops at step 719.

Although the above has been described in terms of a specific sequence of steps, it would be recognized that there can be many alternatives, variations, and modifications. For example, any of the above steps can be separated or combined. Alternatively, some of the steps can be implemented in software or a combination of hardware and software. Alternatively, the above steps can be further integrated in hardware or software or hardware and software or the like. It is also understood that the examples and embodiments described herein are for illustrative purposes only and that various modifications or changes in light thereof will be suggested to persons skilled in the art and are to be included within the spirit and purview of this application and scope of the appended claims.

It is also understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes in their entirety.

What is claimed is:

1. A noise reduction apparatus comprising:
a housing;
a processing device coupled to the housing;
a sensor coupled to the processing device and adapted to the housing, the sensor being adapted to determine a noise signal;
a programmable memory coupled to the processing device, the programmable memory device comprising 1 to N periodic frequency band limited noise wave shapes, one or more of the periodic frequency band limited noise wave shapes being capable of reducing an intensity level of the noise signal; and
an output device coupled to the processing device, the output device being adapted to output the periodic frequency band limited noise wave shape that is capable of reducing the intensity level of the noise signal.

2. The apparatus of claim 1 further comprising an amplifier coupled to the sensor, the amplifier being adapted to increase an intensity level of the noise signal.

3. The apparatus of claim 1 wherein the output device is a speaker coupled to the housing, the speaker being coupled to reduce the intensity level of the noise signal.

4. The apparatus of claim 1 wherein the processing device is a digital signal processing device, a micro processor, or a micro controller.

5. The apparatus of claim 1 further comprising a peak detector coupled to the processing device, the peak detector being adapted to determine a peak of the noise signal.

6. The apparatus of claim 1 further comprising a plurality of band filters 1 to N coupled to the sensor, each of the each band filters being adapted to derive a band output 1 to N, each of the band output having a phase and amplitude information retrieved by a peak detector and a phase lock loop device.

7. The apparatus of claim 1 wherein the programmable memory is a flash memory device.

8. The apparatus of claim 1 wherein the memory is a flash memory device, the flash memory device including a plurality of memory cells, each of the memory cells being capable of storing an analog voltage level.

9. The apparatus of claim 1 further comprising an amplifier coupled to the processing device, the amplifier being adapted to increase an intensity level of one or more of the periodic frequency band limited noise wave shapes.

10. The apparatus of claim 1 wherein the programmable memory is capable of storing analog audio information.

11. A method for reducing undesirable audio using a programmable semiconductor memory device, the method comprising:
receiving incoming audio information from a substantially continuous stream of the audio information;
filtering the incoming audio information into a plurality of wave forms, each of the wave forms having a plurality of components, each of the components including a phase information and an amplitude information;
identifying one or more wave forms having a phase information and an amplitude information from a library of preprogrammed audio information;
selecting the one or more wave forms from the library; and
outputting information from one or more of the wave forms in a selected manner to substantially reduce an intensity level of a portion of the substantially continuous stream of the audio information.
